(19) United States
(12) Patent Application Publication
(10) Pub. No.: US 2017/0374692 A1
(43) Pub. Date: Dec. 28, 2017

(54) CONFIGURATION OF ACCESS POINTS IN A COMMUNICATION NETWORK

(71) Applicant: SolutionInc Limited, Halifax (CA)

(72) Inventors: James Randolph Currie, Halifax (CA); Mark Philip Landry, Halifax (CA); Charles Arthur Taylor Feild, Halifax (CA); Keith Macpherson Small, Halifax (CA)

(21) Appl. No.: 15/191,291

(22) Filed: Jun. 23, 2016

(51) Int. Cl. H04W 76/02; H04L 12/46; H04W 8/24; H04W 12/06

(52) U.S. Cl. CPC H04W 76/02; H04W 12/06; H04L 12/4675; H04W 8/24

(57) ABSTRACT

Network components can be configured in order to allow multiple communication devices of transient users, such as hotel guests, to automatically connect to the network infrastructure. A device of the user may specify network access information that is known by all of the user's devices to configuration functionality that in turn configures the network components, such as one or more wireless access points in order to advertise the network details that are already known by the user's multiple devices.

### TECHNICAL FIELD

The current disclosure relates to configuring a communication network and in particular to configuring access points in the communication network.

### BACKGROUND

Hotels, motels or other locations where multiple users, guests or tenants may stay, may offer network access. The network access may be provided by a ‘guest’ wired or wireless network that communication devices can connect to. While providing network access is advantageous to the users, guests or tenants, it may require selecting the particular ‘guest’ network, and entering a password in order to connect to the network. The selection of the network and entering of the password may be momentarily difficult. Additionally, when a user, guest, or tenant has multiple devices, the network would need to be selected and the password entered on each of the multiple devices. Further, having the user select the particular network to connect to may present opportunities for spoofing of the network name in order to have users unknowingly connect to an un-trusted network. Further still, the network access may be provided as a common network that is accessed by all users, guests or tenants, which may expose individual's information to others on the network.

### SUMMARY

In accordance with the present disclosure there is provided a method for configuring a physical network comprising a plurality of wireless access points, the method comprising: receiving, at a configuration server, network access information used by at least one network communication device of a user for connecting to a network; and configuring one or more access points of the plurality of access points using the received network access information to allow one or more communication devices configured with the network access information to automatically connect to the configured one or more access points.

In a further embodiment of the method, the network access information is received within a request for configuring the one or more access points.

In a further embodiment of the method, the network access information comprises a network identifier and an authentication credential.

In a further embodiment, the method further comprises determining the one or more access points to configure.

In a further embodiment of the method, determining the one or more access points to configure comprises: determining a room or location associated with the user; and determining at least one access point associated with the determined room or location.

In a further embodiment of the method, the user is associated with a locally unique identifier (LUID) and determining the one or more access points to configure comprises determining at least one access point associated with the LUID.

In a further embodiment of the method, determining the one or more access points to configure comprises: receiving an indication of the one or more access points to configure from a network communication device of the user.

In a further embodiment of the method, the network communication device of the user determined the one or more access points to configure based on received signal strength indicators received from a plurality of access points.

In a further embodiment of the method, determining the one or more access points to configure comprises: determining the one or more access points to configure based on a network access point the network access information was received from.

In a further embodiment of the method, the configuration server stores the network access information in association with a locally unique identifier (LUID) associated with the user in a database.

In a further embodiment of the method, configuring the one or more access points comprises retrieving the network access information associated with the LUID from the database.

In a further embodiment of the method, the configuration server removes the network access information from the configuration server once the one or more access points are configured.

In a further embodiment of the method, configuring the one or more access points comprises: configuring the one or more access points to broadcast only a single network identifier.

In a further embodiment of the method, configuring the one or more access points comprises: assigning the network traffic of the network provided by the one or more access points configured based on the network access details to a virtual local area network (VLAN).

In a further embodiment, the method further comprises authenticating and/or authorizing network access over the configured one or more access points.

In a further embodiment of the method, configuring the configuring the one or more access points comprises configuring the one or more access points to perform network address translation (NAT) for a plurality of communication devices connected to the one or more configured access points using the network access information.

In a further embodiment of the method, the network access information is received from a mobile communication device of the user.

In a further embodiment of the method, the mobile communication device of the user detects and connects to a pre-defined network identifier and transmits the network access information to the configuration server over the pre-defined network.

In a further embodiment, the method further comprises verifying an identity of the configuration server prior to transmitting the access information.

In accordance with the present disclosure there is provided a server for use in configuring a physical network comprising a plurality of wireless access points, the server comprising: at least one memory unit for storing instructions; and at least one processing unit for executing the instructions stored in the at least one memory unit, the instructions, which when executed by the at least one processing unit, configuring the server to: receive network access information used by at least one network communication device of a user for connecting to a network; and configure one or more access points of the plurality of access points using the received network access information to allow one or more communication devices configured with the network access information to automatically connect to the configured one or more access points.

In a further embodiment of the server, the network access information is received within a request for configuring the one or more access points.

In a further embodiment of the server, the network access information comprises a network identifier and an authentication credential.

In a further embodiment of the server, the server is further configured to determine the one or more access points to configure.

In a further embodiment of the server, determining the one or more access points to configure comprises: determining a room or location associated with the user; and determining at least one access point associated with the determined room or location.

In a further embodiment of the server, the user is associated with a locally unique identifier (LUID) and determining the one or more access points to configure comprises determining at least one access point associated with the LUID.

In a further embodiment of the server, the server is configured to determine the one or more access points to configure by: receiving an indication of the one or more access points to configure from a network communication device of the user.

In a further embodiment of the server, the network communication device of the user determined the one or more access points to configure based on received signal strength indicators received from a plurality of access points.

In a further embodiment of the server, the server is configured to determine the one or more access points to configure by: determining the one or more access points to configure based on a network access point the network access information was received from.

In a further embodiment of the server, the server is further configured to store the network access information in association with a locally unique identifier (LUID) associated with the user in a database.

In a further embodiment of the server, the server is configured to configure the one or more access points by retrieving the network access information associated with the LUID from the database.

In a further embodiment of the server, the server is further configured to remove the network access information from the server once the one or more access points are configured.

In a further embodiment of the server, the server is configured to configure the one or more access points by: configuring the one or more access points to broadcast only a single network identifier.

In a further embodiment of the server, the server is configured to configure the one or more access points by: assigning the network traffic of the network provided by the one or more access points configured based on the network access details to a virtual local area network (ULAN).

In a further embodiment of the server, the server is further configured to authenticate and/or authorize network access over the configured one or more access points.

In a further embodiment of the server, the server is further configured to configure the one or more access points to perform network address translation (NAT) for a plurality of communication devices connected to the one or more configured access points using the network access information.

In accordance with the present disclosure there is further provided a mobile device for use in configuring a physical network comprising a plurality of wireless access points, the mobile device comprising: at least one memory unit for storing instructions; and at least one processing unit for executing the instructions stored in the at least one memory unit, the instructions, which when executed by the at least one processing unit, configuring the mobile device to: receive an indication of a user's desire to configure one or more access points of the plurality of wireless access points; upon receiving the indication, accessing network access information used by the mobile device in connecting to a wireless network; and transmitting the network access information to a configuration server for use in configuring the one or more access points.

In a further embodiment, the mobile device is further configured to: detect and connect to a pre-defined network identifier; and transmit the network access information to the configuration server over the pre-defined network.

In a further embodiment, the mobile device is further configured to verify an identity of the configuration server prior to transmitting the access information.

### BRIEF DESCRIPTION OF THE DRAWINGS

Embodiments are described herein with reference to the appended drawings, in which:

FIG. 1 depicts configuring of access points in a hotel environment;

FIG. 2 depicts a network with configurable access points;

FIG. 3 depicts a network of configured access points;

FIG. 4 depicts a process for configuring access points; and

FIG. 5 depicts a mobile device and method for use in configuring access points.

### DETAILED DESCRIPTION

Visitor-based local-area computer Networks (VBNs) are common at most hotels today. A VBN may comprise a logical and/or physical portion of a hotel's local area computer Network (LAN) which is available for use by the hotel's guests. The VBN may provide a means for a hotel's guests to access the Internet as well as the hotel's own network services such as guest services, Video-on-Demand servers, telephony and/or business services. A VBN is usually specially designed to facilitate network use by a number of transient and arbitrary users, often while applying billing models, enforcing network security rules, and intelligently allocating network resources to the users.

Access to contemporary VBNs is often available wirelessly, so that modern computing devices such as cell phones, computer tablets, laptop computers, cameras, etc. can connect to the VBN without the need for assorted cables and adapters. However, the availability of wireless access to VBNs does not provide an un-intrusive network connection experience, nor does it ensure a secure computing environment. In order to connect to a VBN wirelessly, the user must choose to connect to a particular wireless network resource, typically identified by a service set identifier (SSID) which is advertised by the hotel's wireless networking access points (APs). Often, multiple SSIDs will be available and thus the selection of the appropriate SSID, and the entry of an associated wireless security passcode, or other authentication credentials, can be a momentarily difficult task. Although the selection of the appropriate SSID and entering of the security information may be a relatively minor inconvenience, the selection and entry process may need to be repeated for each user device that the user wishes to connect to the VBN. As described in further detail below, access points of the VBN may be configured, at least partially automatically requiring minimal intervention by a user, in order to allow the user's communication devices to automatically connect to the VBN.

Most modern wireless computing devices are capable of remembering previously connected-to SSIDs and the associated security information such as passcodes, or other authentication credentials, used in connecting to the network. When a user's device is within range of a known network, the device can automatically connect to and authenticate with the known network without any user intervention, although a user may be prompted to confirm whether or not they wish to connect to the network. By providing a mechanism to configure VBN access points with the network access information of a network already known by a user's device, the user's device as well as any other devices configured with the network access information, may automatically connect to the VBN.

The typical wireless VBN user experience may be improved by enabling a user's wireless computing devices to perform a transparent and un-intrusive auto-connection and auto-authentication to a hotel's wireless network infrastructure, even though the hotel network does not normally advertise or otherwise provide any of the user's commonly-used SSIDs.

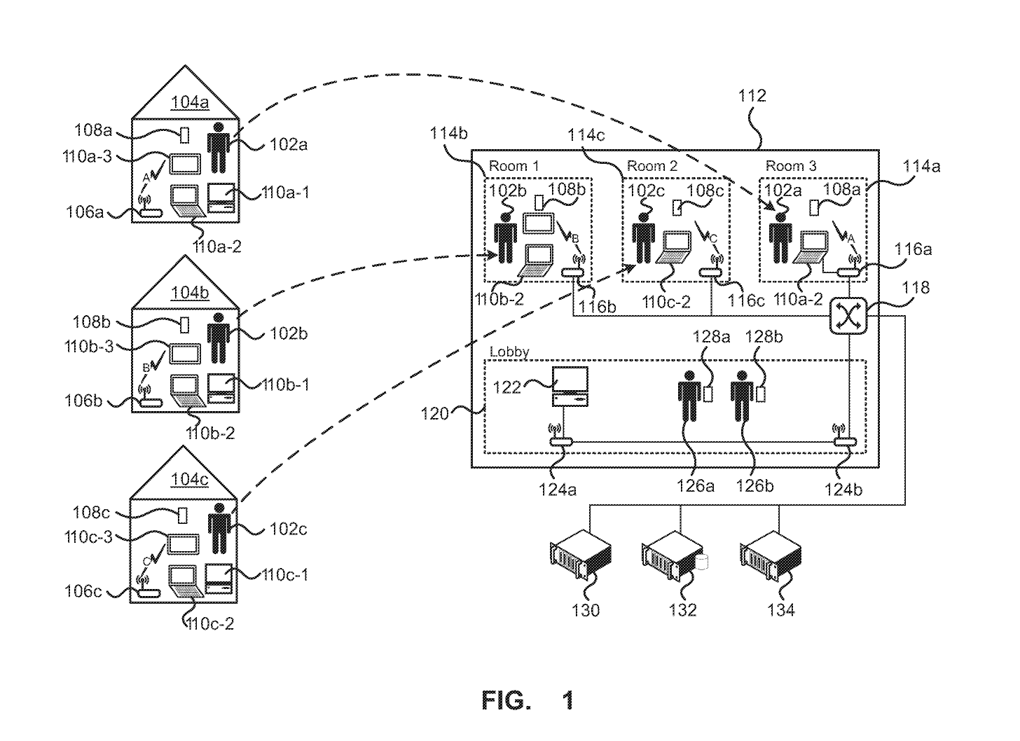

FIG. 1 depicts configuring of access points in a hotel environment. A number of individual users 102a, 102b, 102c (referred to collectively as users 102) are depicted as being located in a home environment 104a, 104b, 104c (referred to collectedly as homes 104) or within a hotel environment 112. The homes 104 each comprise an associated wireless network, depicted as being provided by respective wireless access points 106a, 106b, 106c (referred to collectively as wireless access points 106). Each of the wireless access points is depicted as broadcasting an SSID of “A,” “B,” and “C” respectively. Each of the users 102 may have a number of computing devices including a portable device such as a cell phone 108a, 108b, 108c (referred to collectively as cell phones 108) as well as other additional computing devices 110a-1-110a-3, 110b-1-110b-3, 110c-1-110c-3 (referred to collectively as additional computing devices 110). Each of the cell phones 108 and the additional computing devices 110 may be configured to automatically connect to the respective home network.

As depicted in FIG. 1, the users 102 may stay at a hotel 112. In FIG. 1, each of the users 102 is depicted as having a respective room 114a, 114b, 114c (referred to collectively as rooms 114). Each of the rooms may be associated with a respective access point 116a, 116b, 116c (referred to collectively as access points 116). As depicted, each of the access points 116 is configured to use network access information that is already known by the devices of the users 102, including the users' cell phones 108 and additional devices 110. That is, when the user 102a is staying at the hotel, the access point 116a associated with the room 114a the user is staying in is configured to broadcast an SSID of “A” and to use the same security information as the access point 106a in the user's home 104a. Accordingly, when the user's cell phone 108a and additional devices 110a are within range of the access point 116a the cell phone 108a and additional devices 110a connect to the access point 116a automatically. Similarly, the access point 116b is configured with network access information associated with the user's 102b known network “B” and the access point 116c is configured with network access information associated with the user's 102c known network “C”.

The wireless access points 116 may be connected to, and form part of, the hotel's LAN by various switches, routers, bridges or other network components, which are represented graphically by switch 118. In addition to the wireless access points 116 associated with individual hotel rooms, the hotel's network may include network access in other areas such as a hotel lobby 120 or other common areas. As depicted, the lobby may comprise one or more hotel computing devices such as computers 122 for checking guests in, which may be connected to the hotel network via a wired connection as depicted. The lobby 120 may include one or more access points 124a, 124b that may provide one or more networks, such as a guest network connection, a staff connection etc. A number of individuals 126a, 126b and their associated wireless devices 128a, 128b may connect to a guest network through the wireless access points 124a, 124b. As with the access points 116, the access points 124a, 124b may be connected to the hotel network via the switch 118. The hotel network may include one or more servers 130, 132, 134 for providing various functionality. For example, one server 130 may be a traffic processing node for configuring and controlling network access, a property management server for providing various management functionality for the hotel, and other user functionality server for providing various functionality for the end-user such as video on demand services.

The hotel network includes configuration functionality, referred to as secure personal area network (SPAN) configuration functionality, for use in order configuring the access points 116 to use the user's known network access information to allow automatic device connections. Generally, other guests will not know or have the authentication credentials for connecting to another user's wireless network. That is, even if user “A” is within range of the wireless network “B”, the user will not have the security credentials for connecting to the wireless network. Accordingly, configuring the access points with previously known networks of a user provides a secure personal area network (SPAN) for each of the users within the hotel. The SPAN configuration functionality may receive the network access information from the user, or a device of the user such as their cell phone, and then configure the appropriate wireless access points to use the received network access information for the user. Although the network access information may be provided to the SPAN configuration functionality in various ways, in one embodiment a SPAN app on the user's cell phone transmits the network access information to the SPAN configuration functionality when the user wishes to establish a connection to the access point.

As described above, the hotel's network may include multiple access points 116, 124a, 124b including both wired access ports and wireless access points, a hierarchy of network switching and/or routing devices represented schematically by switch 118, a traffic processing node for the hotel guests' network traffic, and possibly other traffic traversing the hotel's LAN, which may be generically referred to as a visitor based network (VBN) server, and access to local network resources such as a Property Management System (PMS), video on demand (VoD), voice over internet protocol (VoIP) as well as the SPAN configuration functionality.

The VBN server may be capable of, for example, providing network provisioning services such dynamic host configuration protocol (DHCP) services, domain name services (DNS), etc. to the LAN components, including the transient end-users. The VBN server may also perform assorted authentication and authorization services, applying network usage billing rules, and allocating network resources as required or desired. The VBN server may be responsible for processing the network traffic moving between most or all of the hotel LAN components. The VBN server may also act as a network traffic router between the hotel LAN and the hotel's Internet connection.

FIG. 1 depicts an individual access point in each user's individual room. Each of the access points 116 in the rooms 114, may be a low-capacity wireless access point capable of advertising a relatively small number of SSIDs. The presence of numerous low-powered wireless access points may improve overall wireless network coverage within the hotel. The wireless access points may advertise one or more SSIDs at the same time. Each such wireless access point within a segment of the hotel may advertise the same collection of SSIDs, or may advertise different SSIDs. Wireless access points may advertise the SSIDs into neighbouring rooms, thus enabling guests to connect to access points that may be in rooms other than the user's individual hotel room. Accessing the network via access points located in adjacent hotel rooms may be acceptable so long as each guest is able to successfully establish a wireless connection or connections to the LAN.

In addition to, or as an alternative to, using the low-capacity wireless access points, relatively high-capacity access points may be used. A small number of wireless access points capable of transmitting strong radio signals and processing large amounts of network traffic may be used to service a large segment of the hotel, such as an entire floor, or a wing of a floor. The high capacity access points typically advertise a number, and possibly a large number, of SSIDs.

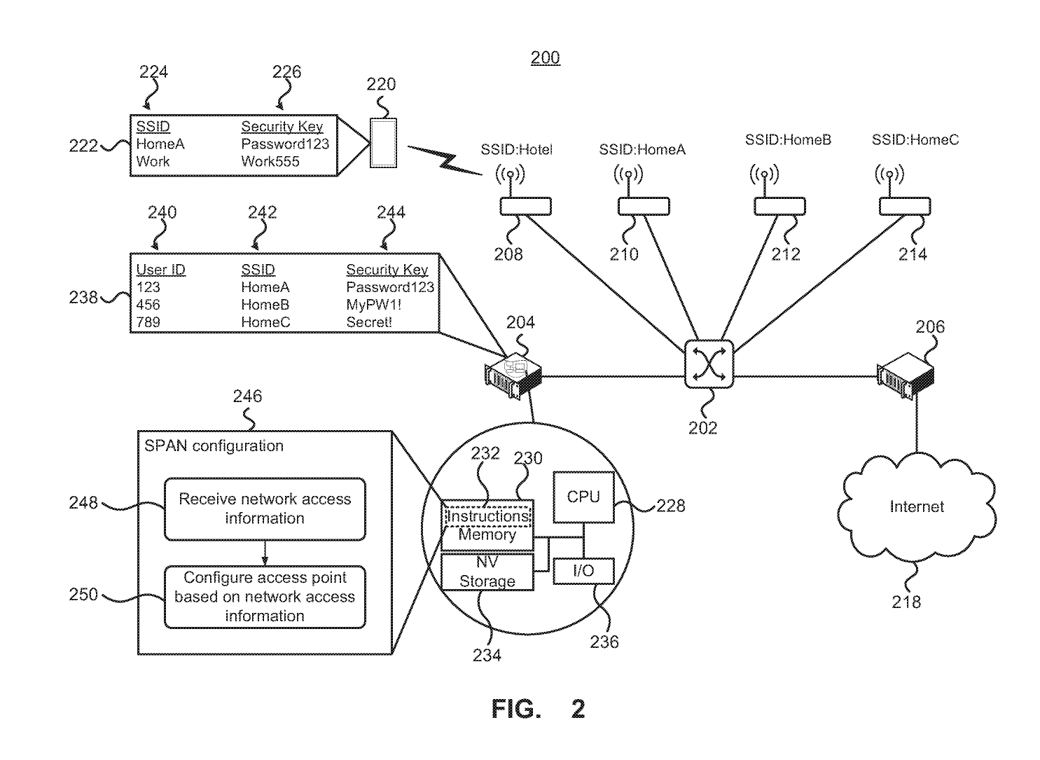

FIG. 2 depicts a network with configurable access points. The access points in the network 200 may be configured in coordination with an app on a mobile device in order to broadcast a network known to the user's mobile devices such as the user's home network. The network depicted in FIG. 2 comprises one or more switches, routers, and/or other networking components, which are depicted schematically as the single switch 202, connecting a configuration server 204 and a traffic controlling server 206 that can monitor, meter authenticate and allow access to the internet 218. A plurality of configurable access points 208, 210, 212, 214 are also connected to the network. The configuration server 204 can communicate with each one of the access points 208, 210, 212, 214 in order configure the access points, including the network access information used by the access points. The network access information includes, for example, the SSID as well as security information for allowing a mobile device to connect to the SSID. The configuration server 204 may receive the network access information from different sources, including, as depicted in FIG. 2, a mobile device that is carried by the user that is in the vicinity of the network system 200. As depicted, the access points may be configured to broadcast one or more SSIDs, including guest-configured SSIDs, depicted as “HomeA”, “HomeB” and “HomeC” as well as hotel networks depicted as “Hotel.” Each of the access points may be configured to broadcast a single SSID in order to ensure that only a single guest's network traffic is carried by the access point. Such a restriction practically ensures that no other guests can utilize the access point, even if the access point's signal extends to other rooms. Thus, the access point's entire capacity is available exclusively to the owner of the custom SSID broadcast by the access point, and there is reduced network security risk at the wireless access point level.

The mobile device may store network access information 222 for a plurality of networks, including for example an SSID 224 of the network along with the security key 226 used for connecting to the SSID. A SPAN app for use in configuring the access points to provide the secure personal area network on the mobile device 220 may augment the mobile device's native SSID/security key recognition and auto-connection mechanism, by performing its own local storage of one or more commonly-used SSID/security key definitions. Alternatively, the SPAN app may access the network access information stored by the device when required, however the device's operating system may restrict access to such network access information to select applications authorized by the operating system and/or operating system vendor. Accordingly, the SPAN app may in practice always maintain its own local store of networking credentials. The SPAN app facilitates interactions with the configuration server and may transmit the network access information associated with one or more stored networks when the user wishes to configure an access point according to the commonly-used networks. The SPAN app is capable of sending a request to the configuration server for creating a commonly-used SSID of the user on the wireless access point. A user's commonly-used SSID may be an SSID that is used by, or at least configured to be used by, one or more devices associated with the user. For example, the commonly-used SSID may be a user's home network, a work network, etc. Additionally or alternatively the commonly-used SSID may be an SSID that the user reserves for use in SPAN configured networks. The access point to be configured with the user's commonly used SSID may be for example an access point located within the user's hotel room. Once the access point is configured according to the commonly used SSID as requested by the SPAN app, any other communication devices configured to connect to the configured SSID will be able to connect to the access point without additional user intervention.

The configuration server may store the user network access information 238, The user network access information may include, for example a user ID 240, an SSID 242 and security key 244 stored in association with each other. The user ID 240 may be associated with the user through the SPAN app on the mobile device 220, or some other process such as through a registration process.

When the user's network access session has expired for example when the user checks out of the hotel, or at the user's explicit request, the configuration server 204 will remove the user's custom SSID/security key definition from the access point and configuration server 204. In order to alleviate possible guest privacy and confidentiality concerns the configuration server may be configured to not maintain a long-term record of the SSID/security key definition. That is, once the configuration server 204 has configured the appropriate access point with the network access information, the network access information may be deleted, or otherwise removed, from the configuration server.

The configuration server 204 is depicted as being provided by a physical server having a processing unit 228 for executing instructions, a memory 230 for storing instructions 232, non-volatile storage 234 and input/output (I/O) interfaces 236 for connecting other devices such as network interfaces to the processing unit 228. The instructions 232, when executed by the processing unit 228, configure the configuration server 204 to provide SPAN configuration functionality 246. As depicted, the SPAN configuration functionality 246 receives network access information (248). The network access information may be sent from a user's mobile device 220, for example when the SPAN app on the mobile device detects the presence of the hotel's network and SPAN configuration server. Alternatively, the network access information may be transmitted to the SPAN configuration server in other ways, for example the user could provide an explicit indication to send the network access information or the user could enter the information into a website during a registration or reservation process. At some point after the user's network access information is received at the SPAN configuration server, it is used to configure one or more access points for the user (250). The one or more access points to be configured may be determined in various ways. For example, a user ID or other identifying information of the user or one or more devices of the user, may be transmitted with the network access information and used to determine a hotel room associated with the user. The hotel room may in turn be used to determine access points associated with the user ID. Alternatively, the user's mobile device may determine the access points to configure, for example based on the strength of signals received from near-by access points or on which access point the user's mobile device has connected to. Once the access point has been configured with a user's commonly-used SSID, any mobile device that has been configured to connect to the SSID can automatically connect to the access points. Although described as possibly using a user ID, the SPAN configuration server may use any form of locally unique identifier (LUID), which could include for example a user ID, an individual's name, a hotel room number, a hotel supplied identifier, other user or personal identifiers, device identifiers, including IP addresses, MAC addresses, or unique identifiers associated with a SPAN app on the device, as well as possible combinations of different identifiers. The LUID allows the SPAN configuration server to determine which access points should be configured with particular network access information as well as to possibly authenticate and authorize network access of devices connecting to the configured network SSID.

As depicted in FIG. 2, each access point may broadcast a single SSID. While access points may be capable of broadcasting multiple network SSIDs at once, the SPAN configuration server 204 can additionally ensure that a guest's access point does not advertise or provide any other SSIDs beyond the SSID configured for the guest. Such a restriction practically ensures that no other guests can utilize the access point, even if the access point's signal extends to other rooms. Thus, the AP's entire capacity is available exclusively to the guest associated with the custom SSID, and there is reduced network security risk at the wireless AP level.

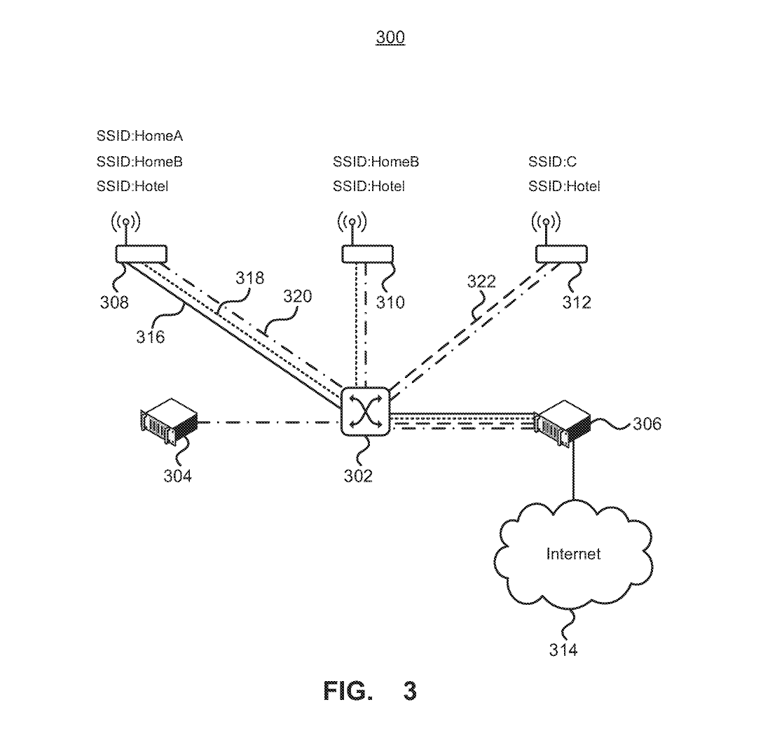

FIG. 3 depicts a network of configured access points. The configuration of access points depicted in FIG. 3 is similar to that described above and as such details that are the same are omitted from further description. The network comprises network switches 302, a SPAN configuration server 304 for configuring access points based on user's commonly-used network access information, and a traffic processing node or server 306, which can connect the hotel network to the internet 314. A number of configurable access points 308, 310, 312 can be configured to provide custom SSIDs based on networks commonly used by the individual guests as well as SSIDs of the hotel. As described above with reference to FIG. 2, each access point may be configured to broadcast a single SSID; however, as depicted in FIG. 3 the access points may alternatively be configured to broadcast a plurality of SSIDs. Regardless of the number of SSIDs broadcast by the access points, the network components can be configured to provide a virtual local area network (VLAN) for each of the SSIDs. Current common networking equipment support one VLAN per SSID; however, it is possible to provide support multiple VLANs per SSID, with for example different types of traffic segregated to each different VLAN. For example voice communication data could be carried on one VLAN and web browsing traffic carried on a second VLAN both accessed over the same network SSID.

VLANs may be established by configuring the network components, including the access points, to tag network traffic of a VLAN with a particular identifier. The tagging of traffic with a VLAN identifier allows other network components, such as switches, to determine which VLAN the traffic is associated with and process the traffic accordingly. The various network components comprising the hotel's LAN should be configured to respect the VLAN tags in order to provide per-VLAN privacy upon the tagged network traffic. As depicted in FIG. 3, a first access point 308 may be configured to broadcast three SSIDs, namely “HomeA,” “HomeB,” and “Hotel,” The HomeA and HomeB SSIDs may be configured for different guests and are intended to indicate an SSID commonly used by the guests at their homes. It is assumed that any communication device a guest is likely to bring with them to a hotel would be able to automatically connect to and authenticate with the network SSID's used in their homes. The Hotel SSID is intended to represent a hotel network, which may be used by guests, or others. The Hotel network may be used by the guests' mobile phones in order to connect to the hotel network infrastructure, including for example SPAN configuration server 304, before a commonly-used SSID has been configured for them. When the access points are configured to provide the guests' SSIDs, the network components may also be configured to provide the network traffic on its own VLAN. The individual VLANs are depicted by different line types in FIG. 3. For example, solid line 316 is intended to depict a ULAN associated with the guest network for the SSID HomeA, dotted line 318 is intended to depict a VLAN associated with the guest network for the SSID HomeB, dashed-dotted line 320 is intended to depict a ULAN associated with the hotel network for the SSID Hotel, and dashed line 322 is intended to depict a VLAN associated with the guest network for the SSID HomeC. As depicted, a single guest SSID, such as HomeB, may be configured to be broadcast on a plurality of different access points 308, 310. The different access points may be separate in-room access points, for example if the guest has multiple rooms, or may be one or more access points provided in common areas of the hotel in order to allow the guest to access their own custom network in the common areas of the hotel.

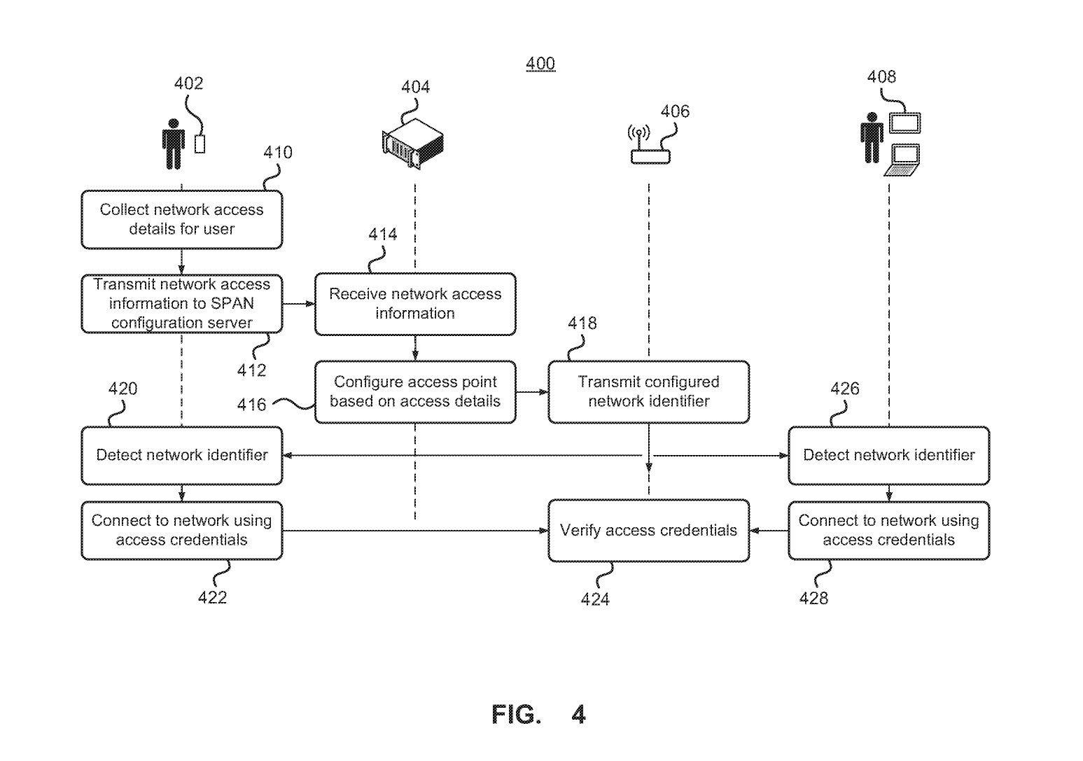

FIG. 4 depicts a process for configuring access points. In FIG. 4 it is assumed a user has a mobile device 402 and a plurality of additional devices 408 such as laptops, tablets, etc, that are each configured to automatically connect to a commonly used network, which for convenience is described as the user's home network. Accordingly, each of the devices 402, 408 are configured with network access information for connecting to the home network. The network access information may include for example the SSID and password or other security information. As depicted, a user's mobile device 402 collects network access details for the user (410). The collection of the network access details may be done by the user's mobile device such as cell phone or other communication devices. Assuming the user's mobile device collects the network access details, the mobile device will comprise one or more network SSIDs, or other network identifier, and associated security information, which may include for example the security key, pass code, pass phrase etc. for authenticating and connecting to the particular network. The operating system of the mobile device may automatically store the network access information of the various known networks. For example, the user's mobile device may automatically store the network access information for networks the mobile device has previously connected to in order to automatically connect to the known networks when in range. Additionally, or alternatively, a specific app on the application such as a SPAN configuration app may collect the network access information in various ways. For example, the SPAN configuration app running on the user's mobile device, or other communication devices of the user, may select the network access information from one or more of the known networks stored on the mobile device. The selection may be explicitly provided by the user selecting one or more of the known networks. Additionally or alternatively, the selection may be performed automatically based on various factors such as the frequency at which the mobile device connects to a particular network, which may involve selecting the network that is connected to the most often, the time of day the network is connected to, which may involve selecting the network that is connected to during some time of the day, such as during a time associated with being at work, etc. Further still, the SPAN app may collect the network access information directly from the user, for example by providing the user with input boxes for specifying a network SSID and associated security information. The SPAN app may collect the particular network access information details for one or more networks.

At some point after collecting the network access details, the mobile device transmits network access information to a SPAN configuration server 404 (412). As described above, SPAN configuration functionality may be provided by one or more servers connected to the hotel LAN. The SPAN configuration server 404 is considered to be any server providing SPAN configuration functionality. The SPAN configuration server 404 may be located on the hotel's LAN, or may be provided by one or more servers located externally from the hotel's LAN. It will be appreciated that the hotel's LAN, including possible firewalls and/or network address translation (NAT) devices, would need to be appropriately configured to allow the externally located SPAN configuration functionality to communicate with network components located on the hotel's internal network. For example, external SPAN configuration functionality could communicate with an internally located SPAN agent that can configure the network components as indicated by the external SPAN configuration functionality. If there are a plurality of possible networks that the mobile device can connect to, the SPAN configuration app on the mobile device may prompt the user for an indication of which network access information should be transmitted. Additionally or alternatively, the SPAN configuration app on the mobile device may select one of the networks based on other information. For example, if the SPAN configuration app determines that the hotel stay is for a work related trip, possibly by a user received indication or evaluation of other information such as calendar appointments, the SPAN configuration app may select a work related network information. Similarly, if the SPAN configuration app determines the hotel stay is a personal trip, the SPAN configuration app may transmit home network access information.

In addition to determining what network access information should be transmitted, the user's mobile device 402 or more particularly the SPAN configuration app on the mobile device may determine when to transmit the network access information. The determination may be made based upon explicit user interactions. For example, a user may provide explicit user input providing an indication that the network access information should be transmitted such as clicking a button or otherwise providing some input. Additionally or alternatively, the determination may be made by detection of one or more wireless networks associated with a SPAN configuration server. For example, the SPAN configuration app may detect a known network such as “Hotel SPAN” or other similar SSID. The SPAN app may cause the user's mobile device to connect to the known SPAN network, or provide instructions for the user to connect to the Hotel SPAN network. Upon connecting to the hotel's SPAN network, or otherwise determining that the network access information should be transmitted to the SPAN configuration server, the mobile device, or more particularly the SPAN configuration app on the mobile device, may authenticate the SPAN configuration server that the network access information is being transmitted to in order to ensure that the server is in fact a valid SPAN configuration server. The authentication process may use any number of techniques for authentication that are known in the network access field. Alternatively, user's mobile device or the SPAN configuration app may be configured to transmit the network access information to a predetermined location, such as a publicly available network address.

In addition to the network access information details that are transmitted, the transmission may include additional information that may be used in configuring the access points. For example, the transmission, which may be in the form of a request for configuring an access point, may include information for use in identifying the access point to be configured. Further, the transmission may include identifying information such as LUID for use in identifying the user or devices, as well as verifying that the user or devices are authorized to configure the access points. The additional information may be provided in various ways. For example, information identifying an access point to configure may be provided explicitly by the user by entering an identifier associated with the access point such as a media access control (MAC) address or Internet Protocol (IP) address. The access point identifier may be manually entered by the user or may input in other ways, such as by scanning a barcode or QR code in the hotel room or in the vicinity of the access point, or through reading a contactless tag such as a near field communication (NFC), radio frequency identification (RFID) tag, Bluetooth low energy (BLE) tag or other means for determining the unique identifier. Alternatively, if the user's mobile device has connected to the Hotel SPAN network wirelessly from the hotel room, the access point may be determined based on where the network communication is received from. Alternatively still, the access point may be determined based on other information such as a hotel room number or user name, which may in turn be associated with one or more access points. As an example, a user may enter name and hotel room number, which is transmitted and may be used to determine an access point providing network coverage to the particular hotel room. The user's name and room number may be used to verify that the user is in fact a guest, and in the correct room as well as possibly authorize that the user is able to configure the access point, for example by verifying that the user has paid, or authorized payment, for the network configuration service. Although described with reference to a combination of guest name and hotel room number, other LUIDs may be used for possibly determining access points to configure as well as verifying that the configuration is authorized.

The SPAN configuration server 404 receives the transmitted network access information (414) and configures one or more access points (416) using information. As described above, the network access information may be received from a user's mobile device in the form of a request to configure an access point. The request may include information indicating network access information to be used as well as information that can be used by the SPAN configuration server in determining the access point, or access points to configure. As described above, the information may include an identification of the user and an identification of the room; however, it is contemplated that various information may be used, such as a user identifier that is otherwise associated with the user's name, room number and/or network access information. The received information is used in determining one or more access points to configure, for example by determining an access point that the request was received from the mobile device at, or by determining a user's hotel room and then determining an access point that provides network coverage for the particular room.

The SPAN configuration server 404 receives the network access information and configures an access point in order to broadcast the particular SSID, or other network identifier, specified by the network access information. The SPAN configuration server may interact with a wide variety of wireless network equipment, such as wireless access points and wireless access point controllers, made by a wide variety of manufacturers, in order to configure the access points as required to broadcast the user's individual SSIDs. Depending upon the particular brands and models of wireless network equipment that is controlled, the SPAN configuration server may interact directly with wireless access points, or it may interact with a wireless access point controller device, which in turn interacts with the wireless access points.

Regardless of the specifics of how the particular access points are configured, the access point 406 determined to be associated with the user is configured to use the network access information for the user. Once configured, the access point 406 transmits, or broadcasts, the configured network identifier (418). As depicted, the user's mobile device 402 may detect the network identifier (420), which the mobile device is configured to automatically detect. Upon detecting the network, the user's mobile device may automatically connect to the network using the known network credentials (422), or may do so after the network is selected by the user. The mobile device exchanges the security information, if required by the network access information, and the access point 406 verifies the access credentials (424) and assuming the correct credentials are provided, the mobile device is connected to the network. As described above, the access point may be configured to transmit an SSID associated with a single user at a time to ensure that all of the access point's bandwidth is dedicated to the user. Further, the configuration of the access point may be associated with the configuration of additional network elements in order to provide a virtual network for the user, which may provide enhanced security to the user.

As depicted in FIG. 4, once the network identifier is broadcast by the access point 406, any additional devices of the user 408 that have been previously configured to connect to the particular network SSID will detect the network identifier (426) and connects to the network using the previously configured access credentials (428), which are verified by the access point (424). Accordingly, the access point configuration described above provides an extremely user friendly experience for configuring network access for the transient guest across multiple devices.

The SPAN configuration app described above may communicate the network access information, as well as other information such as LUIDs, possibly including user IDs, for use in configuring one or more access points. The SPAN configuration app may further interact with a VBN server's authentication mechanism that authenticates and authorizes a user for access functionality such as accessing the Internet. For example, the SPAN configuration app could request network access from the VBN server on behalf of the user, arrange payment by the user if necessary, and then request the creation of a custom SSID, in one simple user action, such as selecting a menu option or tapping a button. Alternatively, the user may authenticate the internet access with the VBN server, using a VBN server's traditional interface and use the SPAN configuration app to request the creation of a custom SSID.

In the case of the SPAN configuration app also performing the VBN server authentication on behalf of the user, the user's in-room wireless access point could be configured, for example by the hotel's administrative staff, or dynamically by the VBN server or by the SPAN configuration server, to perform Network Address Translation (NAT) upon the traffic sent by wireless devices connected to it, so that all of the wireless devices connected to the wireless access point would be NATted by that access point to a single shared IP address. The VBN server would receive the NATted traffic sent from the wireless access point, and would therefore not see a distinct IP address for each wireless device connected to that wireless access point. The VBN server could then authenticate the guest by that single NATted IP address, enabling all of the guest's wireless devices to leverage that single authentication. For example the user's authentication with the VBN server via the user's cell phone, which may be running the SPAN configuration app, would automatically apply to all of the user's other wireless computing devices subsequently connected to the configured access point, by virtue of their shared NATted IP address, even though those other devices have not yet connected to the LAN.

Alternatively, the hotel's LAN could be configured in a manner which enables the SPAN configuration app to interact with the SPAN configuration server, and thus arrange for the creation of custom SSIDs, before the guest has authenticated with the VBN server and gained access to the overall guest LAN and to the Internet. This would obviate the need for the SPAN app to perform VBN server authentication on behalf of the user. The user could instead authenticate his cell phone with the VBN server after the custom SSID has been created, either by connecting to that custom SSID and interacting with the VBN server, or by remaining connected to the public guest SSID and interacting with the VBN server. The guest's additional wireless computing devices could authenticate with the VBN server after connecting to the custom SSID rather than to a public guest SSID.

Additionally, the guest's in-room wireless AP could be configured to not perform NAT upon the guest's network traffic, thus enabling the VBN server to distinguish the guest's individual wireless computing devices by virtue of at least their distinct IP addresses. This would enable the VBN server to apply business rules intended to, for example, monetize or restrict the guest's use of multiple wireless computing devices. In this scenario, some or all of the guest's additional wireless computing devices might be required to authenticate with the VBN server, possibly requiring an additional fee.

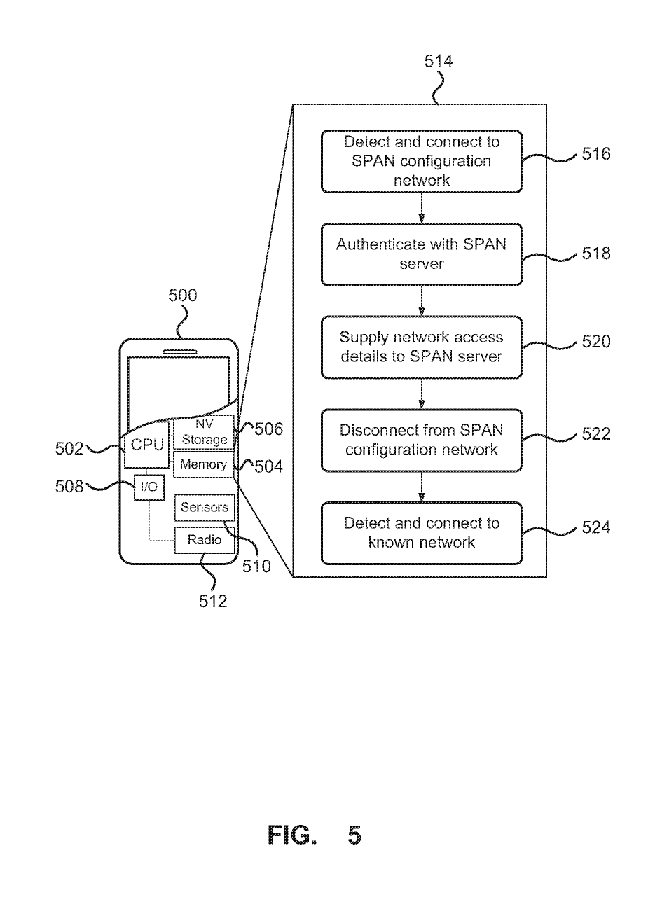

FIG. 5 depicts a mobile device and method for use in configuring access points. The mobile device 500 comprises a central processing unit (CPU) 502 capable of processing instructions for configuring the mobile device to provide various functionality. The instructions executed by the processor 502 may be stored, at least temporarily in memory 504, which may be for example random access memory (RAM), read only memory (ROM), cache memory, or other types of memory. Further, the device 500 may include non-volatile (NV) storage 506 for storage of information that survives power loss. The NV storage 506 may comprise for example flash memory, hard drives, solid state drives. ROM, etc. The mobile device 500 may further comprise one or more input/output (I/O) interfaces 508 that allow additional components to communicate with the processor 502. Although the additional devices may comprise a variety of devices for inputting and/or outputting information, sensors 510 such as gyroscopes, accelerometers, NFC readers, etc. may be provided. Additionally, one or more RF radios 512 for communication may be provided. The RF radios, may include for example cellular radios, Wi-Fi radios, Bluetooth radios, etc.

The instructions stored in the memory 504, when executed by the processor 502 configure the mobile device 500 to provide various SPAN configuration app functionality 514. The SPAN configuration app functionality 514 may communicate with the SPAN configuration server functionality described above. The SPAN configuration app functionality 514 depicted in FIG. 5 assumes that the mobile device's operating system maintains and stores network access information for use in automatically connecting to known networks. Further, it is assumed that one of the networks stored on the device has been selected, or otherwise indicated, as the desired network for configuring access points. The SPAN configuration app 514 may detect that the user has connected to a SPAN configuration network and communicate with a SPAN configuration server (516). Alternatively, if the user has not connected the mobile device to the SPAN configuration network, the SPAN configuration app 514 may communicate with the SPAN configuration server through a publicly accessible server. The SPAN configuration app functionality 514 may authenticate with the SPAN server (518). The authentication may authenticate the SPAN configuration server with the mobile device so that the user trusts that the SPAN configuration server is a legitimate server. The SPAN configuration server may also authenticate the user, for example using a user name and password combination, or some other identifying information such as the user's last name and associated hotel room number. Assuming that authentication of the SPAN configuration server is performed, once the authentication is successful, the network access information is provided to the SPAN configuration server (520). The SPAN configuration server receives the network access information and configures the access point. Once the access point is configured to broadcast the network SSID, the mobile device may disconnect from the SPAN configuration network, or any other networks the mobile device is connected to (522) and subsequently detect and connect to the known network broadcast by the configured access point (524). Although the disconnection and connection are depicted as part of the SPAN configuration app functionality 514, the disconnection and connection may be performed by the mobile devices operating system, or other networking applications or functionality of the mobile device.

Security and confidentiality of the user's SSID/passcode definitions are a major concern, and a significant benefit, of the SPAN model. The SPAN app stores the user's SSID/passcode definitions only within the local storage of SPAN app's wireless computing device, thus leveraging the security mechanisms of that wireless device, Additionally, the SPAN app and the SPAN server ideally communicate using secure transmissions. The SPAN server will ideally never transmit SSID/passcode information to any network entity except for the relevant wireless networking equipment. The SPAN server will ideally not store SSID/passcode information longer than the SSID is required to persist upon the wireless AP. Alternatively, the SPAN server will not store SSID/passcode information at all, and thus require the user to re-request, via the SPAN client, the re-creation of a custom SSID should a network disruption (e.g. a power outage) cause the custom SSID to prematurely disappear from the wireless AP.

Security and confidentiality of the user's SSID/passcode definitions may be a primary or significant concern for a user. The system described above for configuring access points with a user's SSID/passcode may alleviate some of a user's concern by relying on the SPAN configuration app present on the user mobile device to manage the SSID/passcode information. That is, the mobile device, which most user inherently trust, stores the SSID/passcodes and may only communicate the network access information to a SPAN configuration server when it is desired to configure the access point. The SPAN configuration app and the SPAN configuration server may communicate using secure transmissions to further enhance the security. The SPAN configuration server may be configured to never transmit a user's SSID/passcode information to any network entity except for the relevant wireless networking equipment, such as the access point being configured. Further, the SPAN configuration server may only store SSID/passcode information as long as the information is required to persist upon the wireless access point. Alternatively, the SPAN configuration server may be configured to not store the SSID/passcode information at all. However, in such a scenario, the access points may require the user to re-request, via the SPAN configuration app, the re-creation of the user's SSID should a network disruption, such as a power outage cause the user's SSID to prematurely disappear from the wireless access point.

Although the above has described the access point configuration in a hotel environment, similar functionality may be applied to other facilities or locations, where guests stay transiently. That is in locations where the guest is present for a long enough period of time to benefit from the use of Wi-Fi network access, but may not be there permanently and as such may not setup their own network infrastructure. The access point configuration described herein could be applied in creating user specified SSIDs in any type of public wireless computer network that provides the functionality described above.

Although generally described above as communicating over wireless networks, the SPAN configuration app may communicate with the SPAN configuration server using a wired networking device which has obtained wired network access to the hotel's network. In such a scenario, the SPAN configuration server would not be able to identify the user's access point by querying the wireless networking infrastructure using the user's MAC and or IP addresses, or using other means as described above. Further, the above has described the creation of networks secured by a passcode. It is possible to configure an access point to provide a network that is not secured with passcodes, should the user request it, for example if the user's commonly-used SSID is not secured by passcodes on the user's commonly-used networks, or if the user simply does not wish his/her SPAN-created SSIDs to utilize passcode security.

The present disclosure provided, for the purposes of explanation, numerous specific embodiments, implementations, examples and details in order to provide a thorough understanding of the invention. It is apparent, however, that the embodiments may be practiced without all of the specific details or with an equivalent arrangement. In other instances, some well-known structures and devices are shown in block diagram form, or omitted, in order to avoid unnecessarily obscuring the embodiments of the invention. The description should in no way be limited to the illustrative implementations, drawings, and techniques illustrated, including the exemplary designs and implementations illustrated and described herein, but may be modified within the scope of the appended claims along with their full scope of equivalents.

While several embodiments have been provided in the present disclosure, it should be understood that the disclosed systems and components might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A method for configuring a physical network comprising a plurality of wireless access points, the method comprising:
receiving, at a configuration server, network access information used by at least one network communication device of a user for connecting to a network; and
configuring one or more access points of the plurality of access points using the received network access information to allow one or more communication devices configured with the network access information to automatically connect to the configured one or more access points.

2. The method of claim 1, wherein the network access information is received within a request for configuring the one or more access points.

3. The method of claim 1, wherein the network access information comprises a network identifier and an authentication credential.

4. The method of claim 1, further comprising determining the one or more access points to configure.

5. The method of claim 4, wherein determining the one or more access points to configure comprises:
determining a room or location associated with the user; and
determining at least one access point associated with the determined room or location.

6. The method of claim 4, wherein the user is associated with a locally unique identifier (LU ID) and determining the one or more access points to configure comprises determining at least one access point associated with the LUID.

7. The method of claim 4, wherein determining the one or more access points to configure comprises:
receiving an indication of the one or more access points to configure from a network communication device of the user.

8. The method of claim 7, wherein the network communication device of the user determined the one or more access points to configure based on received signal strength indicators received from a plurality of access points.

9. The method of claim 4, wherein determining the one or more access points to configure comprises:
determining the one or more access points to configure based on a network access point the network access information was received from.

10. The method of claim 1, wherein the configuration server stores the network access information in association with a locally unique identifier (LUID) associated with the user in a database,

11. The method of claim 10, wherein configuring the one or more access points comprises retrieving the network access information associated with the LUID from the database.

12. The method of claim 1, wherein the configuration server removes the network access information from the configuration server once the one or more access points are configured.

13. The method of claim 1, wherein configuring the one or more access points comprises:
configuring the one or more access points to broadcast only a single network identifier.

14. The method of claim 1, wherein configuring the one or more access points comprises:
assigning the network traffic of the network provided by the one or more access points configured based on the network access details to a virtual local area network (VLAN).

15. The method of claim 1, further comprising authenticating and/or authorizing network access over the configured one or more access points.

16. The method of claim 1, wherein configuring the configuring the one or more access points comprises configuring the one or more access points to perform network address translation (NAT) for a plurality of communication devices connected to the one or more configured access points using the network access information.

17. The method of claim 1, wherein the network access information is received from a mobile communication device of the user.

18. The method of claim 17, wherein the mobile communication device of the user detects and connects to a pre-defined network identifier and transmits the network access information to the configuration server over the pre-defined network.

19. The method of claim 18, further comprising verifying an identity of the configuration server prior to transmitting the access information.

20. A server for use in configuring a physical network comprising a plurality of wireless access points, the server comprising:
at least one memory unit for storing instructions; and
at least one processing unit for executing the instructions stored in the at least one memory unit, the instructions, which when executed by the at least one processing unit, configuring the server to:
receive network access information used by at least one network communication device of a user for connecting to a network; and
configure one or more access points of the plurality of access points using the received network access information to allow one or more communication devices configured with the network access information to automatically connect to the configured one or more access points.

21. The server of claim 20, wherein the network access information is received within a request for configuring the one or more access points.

22. The server of claim 20, wherein the network access information comprises a network identifier and an authentication credential.

23. The server of claim 20, wherein the server is further configured to determine the one or more access points to configure.

24. The server of claim 23, wherein determining the one or more access points to configure comprises:
determining a room or location associated with the user; and
determining at least one access point associated with the determined room or location.

25. The server of claim 23, wherein the user is associated with a locally unique identifier (LU ID) and determining the one or more access points to configure comprises determining at least one access point associated with the LUID.

26. The server of claim 23, wherein the server is configured to determine the one or more access points to configure by:
receiving an indication of the one or more access points to configure from a network communication device of the user.

27. The server of claim 26, wherein the network communication device of the user determined the one or more access points to configure based on received signal strength indicators received from a plurality of access points.

28. The server of claim 23, wherein the server is configured to determine the one or more access points to configure by:
determining the one or more access points to configure based on a network access point the network access information was received from,

29. The server of claim 20, wherein the server is further configured to store the network access information in association with a locally unique identifier (WO) associated with the user in a database.

30. The server of claim 29, wherein the server is configured to configure the one or more access points by retrieving the network access information associated with the LUID from the database.

31. The server of claim 20, wherein the server is further configured to remove the network access information from the server once the one or more access points are configured.

32. The server of claim 20, wherein the server is configured to configure the one or more access points by:
configuring the one or more access points to broadcast only a single network identifier.

33. The server of claim 20, wherein the server is configured to configure the one or more access points by:
assigning the network traffic of the network provided by the one or more access points configured based on the network access details to a virtual local area network (VLAN).

34. The server of claim 20, wherein the server is further configured to authenticate and/or authorize network access over the configured one or more access points.

35. The server of claim 20, wherein the server is further configured to configure the one or more access points to perform network address translation (NAT) for a plurality of communication devices connected to the one or more configured access points using the network access information.

36. A mobile device for use in configuring a physical network comprising a plurality of wireless access points, the mobile device comprising:
at least one memory unit for storing instructions; and
at least one processing unit for executing the instructions stored in the at least one memory unit, the instructions, which when executed by the at least one processing unit, configuring the mobile device to:
receive an indication of a user's desire to configure one or more access points of the plurality of wireless access points;
upon receiving the indication, accessing network access information used by the mobile device in connecting to a wireless network; and
transmitting the network access information to a configuration server for use in configuring the one or more access points.

37. The mobile device of claim 21, wherein the mobile device is further configured to:
detect and connect to a pre-defined network identifier; and
transmit the network access information to the configuration server over the pre-defined network.

38. The mobile device of claim 22, wherein the mobile device is further configured to verify an identity of the configuration server prior to transmitting the access information.
